(19) United States
(12) Patent Application Publication
(10) Pub. No.: US 2011/0016309 A1
(43) Pub. Date: Jan. 20, 2011

(54) CRYPTOGRAPHIC COMMUNICATION SYSTEM AND GATEWAY DEVICE

(75) Inventors: Shinya MOTOYAMA, Tokyo (JP); Satoshi SHIMIZU, Yokohama (JP); Tadashi NOBE, Yokohama (JP); Junnosuke WAKAI, Zushi (JP)

Correspondence Address: MATTINGLY & MALUR, P.C., 1800 DIAGONAL ROAD, SUITE 370, ALEXANDRIA, VA, 22314, US

(73) Assignee: HITACHI, LTD., Tokyo (JP)

(21) Appl. No.: 12/776,001

(22) Filed: May 7, 2010

(30) Foreign Application Priority Data
Jul. 17, 2009 (JP) 2009-168481

(51) Int. Cl. H04L 9/00

(52) U.S. Cl. 713/153; 713/162; 726/15

(57) ABSTRACT

A GW (PDG) at the termination of remote access is installed in the 3GPP system. After an IPSec tunnel between a terminal and the GW is opened, an IPSec tunnel between a VPN client and the corporate network GW is opened, whereby the data from the terminal is transferred via two tunnels between the terminal and the GW and between the VPN client and the corporate network GW to the corporate network. Also, the GW checks if the destination network uses the global address from the destination IP address of a message received from the terminal making the remote VPN access. If the global address is required, the source IP address of the message received from the terminal is translated from the private address for use within the corporate network to which the terminal is allocated to the global address to transfer the message.

### BACKGROUND OF THE INVENTION

1. Field of the Invention

The present invention relates to a cryptographic communication system and a gateway unit, and more particularly to a cryptographic communication system and a gateway unit for providing a remote VPN access service to a corporate network via a 3GPP system having an IP address translation function.

2. Description of the Related Art

With a Virtual Private Network (VPN) technique using a Security Architecture for the Internet Protocol (IPSec), a remote VPN access has widespread for allowing a member going out to make secure connection via the internet to the company's corporate network.

Referring to FIG. 1, the outline of a remote VPN access system will be described below. In FIG. 1, a terminal 101 is connected via the internet 102 to a corporate network 104. The terminal 101 communicates with an opposed server 105 of the corporate network 104 through a communication link 106, but since the communication link 106 passes through the internet 102, it is required to be secure. The terminal 101 sets up an IPSec tunnel 107 for a VPN gateway unit 103 installed at the edge of the Internet 102 in the corporate network 104. The communication link 106 is maintained as a secure communication path by using the communication link in the IPSec tunnel 107. The above remote VPN access system is disclosed in JP-A-2001-160828, for example.

On the other hand, the 3rd Generation Partnership Project (3GPP) that is a standardization party of a portable telephone network defines the specifications for accommodating the internet access to a 3GPP network via a Wireless Local Area Network (WLAN) in 3GPP TS23.234, 3GPP system to Wireless Local Area Network (WLAN) Interworking—System Description. Referring to FIG. 2, an internet access method via the 3GPP network will be described below. In FIG. 2, the terminal 101 is connected via the WLAN network 201 to the 3GPP network 202. The 3GPP network 202 provides a service for connecting to the internet 102 to the terminal 101. Herein, the terminal 101 connects a communication link 206 between the terminal 101 and the opposed server 105 to communicate with the opposed server 105 connected to the internet 102.

The 3GPP network 202 has an Authentication Authorization Accounting (AAA) 203 that is a server for authenticating the subscriber, a Wireless LAN Access Gateway (WAG) 204 for making the transmission of user data over the WLAN network, and a Packet Data Gateway (PDG) 205 that is a gateway at a packet level. The WLAN network 201 is a non-secure network and sets an IPSec tunnel 207 between the terminal 101 and the PDG 205 to maintain the security of the communication link 206.

### SUMMARY OF THE INVENTION

A case 1 where the terminal makes the remote VPN access to the corporate network connected to the internet using the internet connection service via the 3GPP network will be considered. In this case 1, the terminal 101 sets up a dual IPSec tunnel having the IPSec tunnel to the PDG 205 within the 3GPP network 202 and the IPSec tunnel to the VPN gateway 103 within the corporate network 104. In the terminal 101, a dual IPSec process consumes more CPU resources of the terminal, resulting in a problem on the performance and consumption power at the terminal having low throughput.

Referring to FIGS. 3 and 4, the above-mentioned problem will be described below in detail. Referring firstly to FIG. 3, a case where the terminal 101 connects to the opposed server 105 in the corporate network 104 connected to the internet 102 using the internet connection service provided by the 3GPP network 202 will be described below. It is supposed that the terminal 101 is connected to the corporate network 104, to which the opposed server 105 belongs, with the remote VPN using the IPSec. An application operating between the terminal 101 and the opposed server 105 communicates through the communication link 206. Herein, to maintain the security of the access from the terminal 101 via the internet, an IPSec tunnel 301 is set up between the terminal 101 and the VPN gateway 103 and used during the communication through the communication link 206. On the other hand, in the 3GPP network 202, an IPSec tunnel 207 is established between the terminal 101 and the PDG 205 to maintain the security of the communication via the WLAN network 201. Herein, both the IPSec tunnel 207 and the IPSec tunnel 301 are terminated at the terminal 101.

Referring to FIG. 4, a protocol stack of the network of FIG. 3 will be described below. In FIG. 4, a protocol stack 401 of the terminal 101 includes an L1/L2 protocol, a Transport IP protocol, an IPSec Tunnel protocol, a Remote IP protocol, an IPSec Tunnel protocol and an IP protocol in order from the lower layer. A protocol stack 402 of the WAG 204 includes the L1/L2 protocol and the Transport IP protocol in order from the lower layer.

A protocol stack 403 of the PDG 205 includes the L1/L2 protocol, the Transport IP protocol, the IPSec Tunnel protocol and the Remote IP protocol on the side of the WAG, and the L1/L2 protocol and the Remote IP protocol on the side of the VPN gateway 103 in order from the lower layer. A protocol stack 404 of the VPN gateway 103 includes the L1/L2 protocol, the Transport IP protocol, the IPSec Tunnel protocol and the Remote IP protocol on the side of the PDG 205, and the L1/L2 protocol and the IP protocol on the side of the opposed server 105 in order from the lower layer. A protocol stack 405 of the opposed server 105 includes the L1/L2 protocol and the IP protocol in order from the lower layer.

An IP packet between the terminal 101 and the opposed server 105 has the IPSec tunnel terminated at the terminal 101 and the VPN gateway 103 on the lower layer. Further, this IPSec tunnel has the IPSec tunnel terminated between the terminal 101 and the PDG 205 at both of them, on the lower layer.

Seeing the protocol stack 401 of the terminal 101, the IP packet between the terminal 101 and the opposed server 105 is doubly processed for the IPSec, and software of the terminal 101 is required to doubly perform the processing of IPSec. That is, at the terminal 101, throughput of the CPU is greatly consumed for the IPSec processing.

A first object of the invention is to avoid the duplicate encryption process of the terminal.

Next, a case 2 where the terminal gaining the remote VPN access to the corporate network connected to the internet using the internet connection service via the 3GPP network uses the internet while connection is held after connecting to the corporate network will be described below. In this case, the terminal has a private address for use only within the corporate network paid from the VPN gateway in connecting to the VPN gateway of the corporate network. The terminal can be connected to the server within the corporate network, using the paid private address, but there is a problem that the terminal can not gain access to another server on the internet because of the use of the private address.

Referring FIG. 5, the above-mentioned problem will be described below in more detail.

The terminal 101 has a private address for use only within the corporate network paid from the VPN gateway 103 in connecting to the VPN gateway 103 of the corporate network 104. The terminal 101 can be connected to the opposed server 105 within the corporate network 104, using the paid private address. Herein, gaining access to a WWW server 501 on the internet is considered. Though a global address is required on the internet, the terminal 101 can not gain access to the WWW server 501, because the terminal 101 can only use the private address while connection to the VPN gateway 103 is held. For the terminal to acquire the global address, it is required to once cut the connection to the VPN gateway 103, in which the system can not be changed seamlessly. Also, it is not possible to use the internet at the same time while using the server within the corporate network, whereby the user of the terminal 101 is obliged to have great inconvenience. On the other hand, when the terminal 101 using the internet is connected to the server within the corporate network 104, it is required that the terminal 101 is connected to the VPN gateway 103 to have the private address paid for use only within the corporate network. Also in this case, it is not possible to use the server within the corporate network while connection to the internet is held.

A second object of the invention is to enable the terminal to use the server on the internet seamlessly while connection to the corporate network is held.

Finally, a case 3 where the terminal gains access to the server on the internet while moving will be considered. In this case, the terminal gains access to the server on the internet via the PDG installed in the WLAN network in each zone, but there are many servers such as the WWW server in which the terminal gains access not directly but indirectly via the Proxy server. In such cases, the Proxy server is installed at the latter stage of the PDG, and access is made to the WWW server via the Proxy server. Herein, if the terminal gains access to the WWW server via the Proxy server, access to another WLAN network occurs in the zone of destination, whereby at least one Proxy server is required in each zone. Likewise, if access is made via any other device than the Proxy server, it is required that at least one other device is installed at the latter stage of the PDG. This zone is in most cases set at such a granularity as prefecture unit, for example, and if the device is distributed in the prefecture units every time the device is increased, the service provider has large burden in view of the troublesomeness of operating at the distribution base and the cost of preparing a plurality of devices.

A third object of the invention is to make it possible to transfer only the necessary communication to the intensive device depending on the communication conditions when the service provider adds the device via which the terminal gains access to the server on the internet.

As described above, one of the objects of the invention is to avoid the duplicate encryption process of the terminal. Moreover, one of the objects of the invention is to enable the terminal to use the server on the internet seamlessly while connection to the corporate network is held. Furthermore, one of the objects of the invention is to make it possible to transfer only the necessary communication to the intensive device depending on the communication conditions when the service provider adds the device via which the terminal gains access to the server on the internet.

In order to solve the above-mentioned problems, the invention introduces a communication system in which a VPN client is disposed at the latter stage of a PDG in a 3GPP network.

This communication system has a terminal, an AAA for enabling the terminal to make the authentication, a PDG connected to the terminal through the cryptographic communication via the WLAN network, a VPN client for making the tunnel setting for encryption at the request of the PDG, an opposed server connected through the cryptographic communication via a corporate network to the VPN client, and a server connected through the non-cryptographic communication via the internet to the PDG.

In this communication system, the PDG comprises a communication block processing section for blocking the communication of the terminal and asking for the authentication when firstly accessed from the terminal, a VLAN setting section for registering the VLAN for the terminal to identify the terminal between the PDG and the VPN client after being notified of authentication success of the terminal from the AAA, a tunnel setting section for setting the first tunnel of the WLAN network between the terminal and the PDG at the request from the terminal, a tunnel setting sending section for sending a request for setting the second tunnel in the corporate network after setting the first tunnel of the WLAN network, a message receiving section for receiving the message via the first tunnel from the terminal, and a message transfer section for transferring the message received via the first tunnel from the terminal to the opposed server via the second tunnel, and can solve one of the above-mentioned problems on the performance and power consumption through a dual encryption process of the terminal.

Also, in this communication system, the PDG comprises an IP address translation table storing the information for translating the source IP address of the message to the corporate network or global IP address, an address translation section for searching the IP address translation table, based on the destination IP address of the message or the source IP address of the message, and translating the source address of the message to the corporate network or global IP address, based on the search result, and a message transfer section for transferring the message in which the source IP address is translated to the IP address of the corporate network to the corporate network via the second tunnel of the corporate network, or the message in which the source address is translated to the IP address of the internet network to the internet, and can solve one of the above-mentioned problems that the terminal can not use the server on the internet seamlessly while holding the connection to the corporate network.

More specifically, in this communication system, the address translation section translates the source IP address to the private IP address for use only within the second network when the destination IP address is the opposed server, and translates the source IP address from the private IP address to the global IP address when the destination IP address is the destination of the server.

Moreover, in this communication system, the PDG comprises a transfer destination judgment section for judging whether the transfer destination of the received message is the internet or the communication device such as the Proxy server depending on the communication conditions such as the source IP address and the destination port number of the message received from the terminal, whereby it is possible to transfer only the necessary communication to the communication device intensively disposed depending on the communication conditions.

According to the first solving means of this invention, there is provided a cryptographic communication system comprising:

a gateway device that communicates with a terminal by a cryptographic communication via a first tunnel in a first network, and communicates with a first server via a second network; and

a VPN client device that sets a second tunnel at least on the second network and makes the cryptographic communication via the second tunnel between the gateway device and a second server in a third network;

wherein the gateway device includes:

a message receiving section for receiving a message via the first tunnel from the terminal communicating by using an arbitrary IP address;

an address storage section for storing one or more IP addresses of the second network and the third network to be assigned to the terminal;

an address translation section for selecting one of the IP addresses of the second network or the third network in the address storage section in accordance with a destination of received message, and translating a source address of the message to the selected IP address of the second network or the third network; and

a message transfer section for transferring the address translated message, in accordance with the destination, to the first server or to the second server via the VPN client device.

According to the second solving means of this invention, there is provided a gateway device in a system which includes the gateway device that communicates with a terminal by a cryptographic communication via a first network, a first server that communicates with the gateway device via a second network, and a second server of a third network that communicates with the gateway device the cryptographic communication at least in the second network, the gateway device comprising;

a message receiving section for receiving a message by the cryptographic communication from the terminal communicating by using an arbitrary IP address;

an address storage section for storing one or more IP addresses of the second network and the third network to be assigned to the terminal;

an address translation section for selecting one of the IP addresses of the second network or the third network in the address storage section in accordance with a destination of received message, and translating a source address of the message to the selected IP address of the second network or the third network; and

a message transfer section for transferring the address-translated message in accordance with the destination address.

According to the invention, when the terminal using the internet access via the WLAN network provided by the 3GPP network uses the remote VPN of the corporate network, it is possible to avoid the influence on the performance due to the dual processing of the IPSec. Also, according to the invention, when the terminal using the internet connection service via the 3GPP network uses the remote VPN of the corporate network, it is possible to utilize the service on the internet seamlessly while connection to the corporate network is held. Further, according to the invention, in adding the communication device via which the terminal is interconnected, it is possible to intensively dispose the communication device without need of installing the communication device in each zone.

### BRIEF DESCRIPTION OF THE DRAWINGS

FIG. 1 is a block diagram for explaining the remote VPN access.

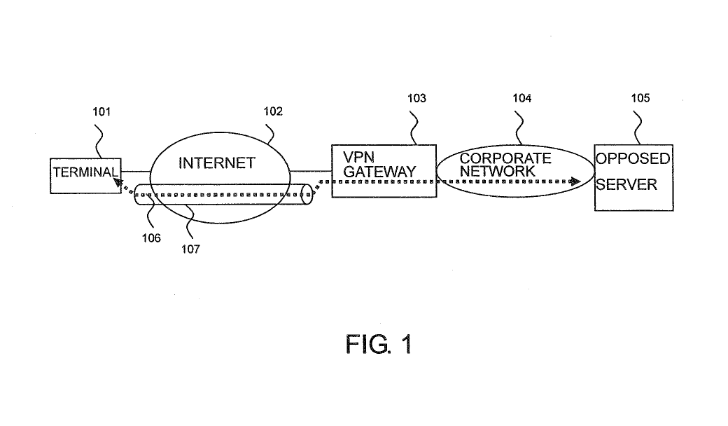

FIG. 2 is a block diagram for explaining the internet access using the 3GPP.

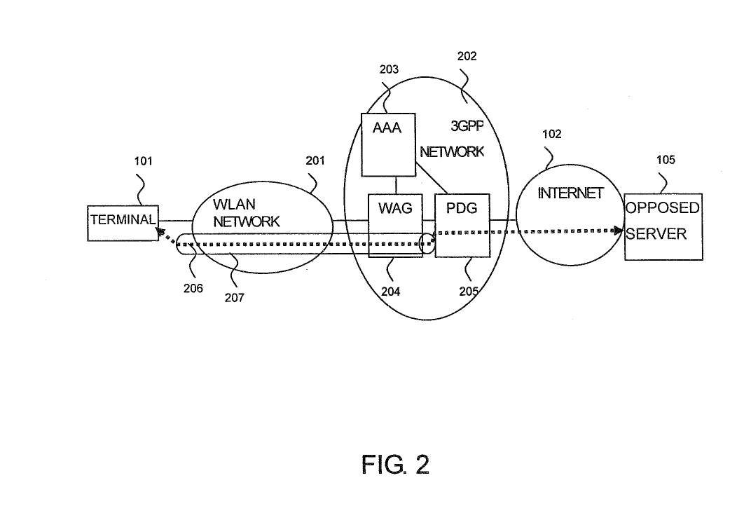

FIG. 3 is a block diagram for explaining the remote VPN access using the 3GPP.

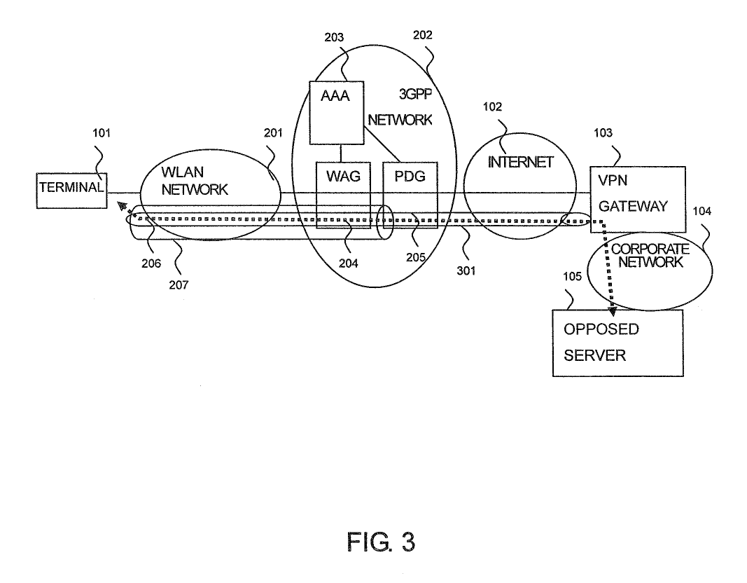

FIG. 4 is a block diagram for explaining the protocol stack for the remote VPN access using the 3GPP.

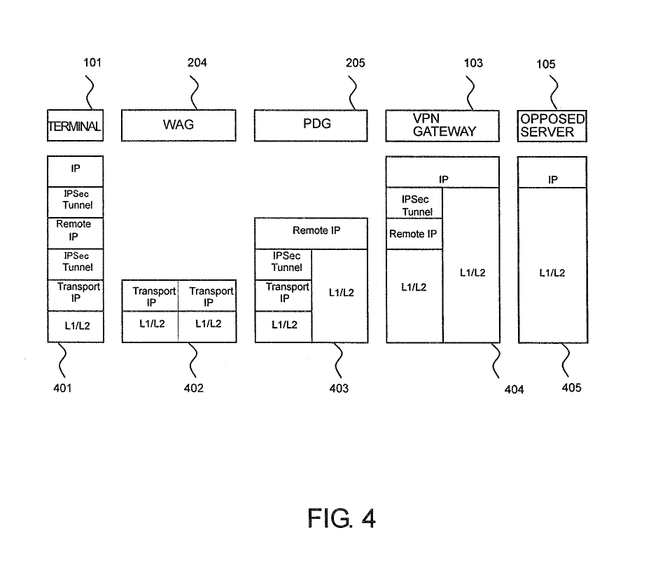

FIG. 5 is a block diagram for explaining the connection to an external server in the remote VPN access using the 3GPP.

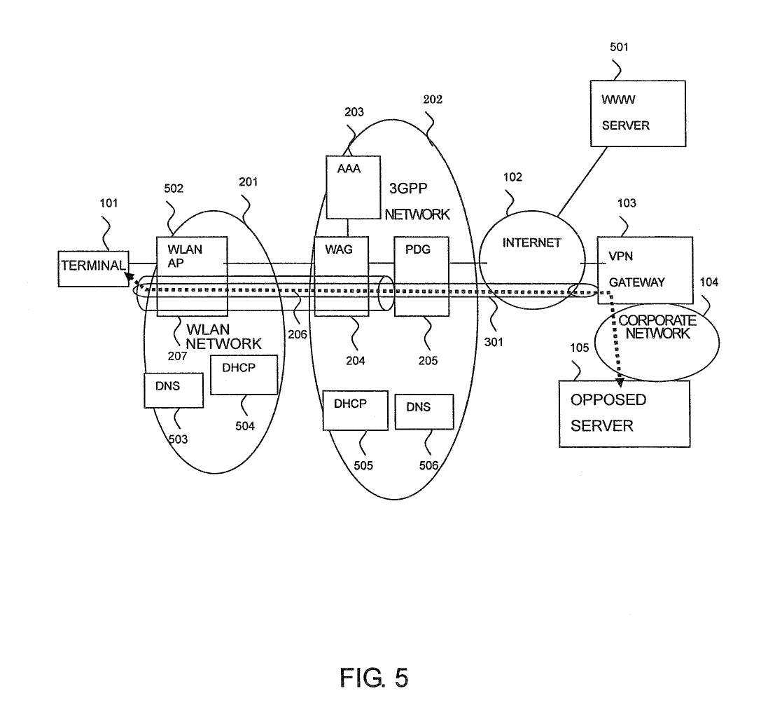

FIG. 6 is a block diagram for explaining the communication with an opposed server in the remote VPN access using the invention.

FIG. 7 is a block diagram for explaining the protocol stack in making the remote VPN access using the invention.

FIG. 8 is a sequence chart for the terminal, WLAN Access Point (AP), AAA, Dynamic Host Configuration Protocol (DHCP) of the WLAN network, Domain Name Server (DNS), PDG, DHCP of the 3GPP network, VPN client, VPN gateway and the opposed server.

FIG. 9 is a terminal information table within the PDG.

FIG. 10 is a flowchart for the IP address translation and transfer that are performed in the PDG at the time of receiving data from the terminal.

FIG. 11 is an IP address table having a list of IP addresses for use within the corporate network.

FIG. 12 is an IP address table having a list of global addresses that can be used by the PDG.

FIG. 13 is a flowchart for the IP address translation and transfer that are performed in the PDG at the time of receiving data from the opposed server.

FIG. 14 is a view for explaining the remote access to a plurality of corporate networks using the internet connection service of the 3GPP network.

FIG. 15 is a configuration diagram of the functional blocks in the PDG.

FIG. 16 is a view for explaining the access via the Proxy server to the WWW server on the internet from the terminal.

FIG. 17 is a view for explaining a communication system in which the device via which the terminal is interconnected can be intensively installed.

FIG. 18 is a transfer destination determination table that the PDG has.

FIG. 19 is a configuration diagram of the functional blocks in the PDG.

### DETAILED DESCRIPTION OF THE INVENTION

An embodiment of the invention will be described below in detail with reference to the drawings. The same or like parts are designated by the same reference numerals and not described repeatedly.

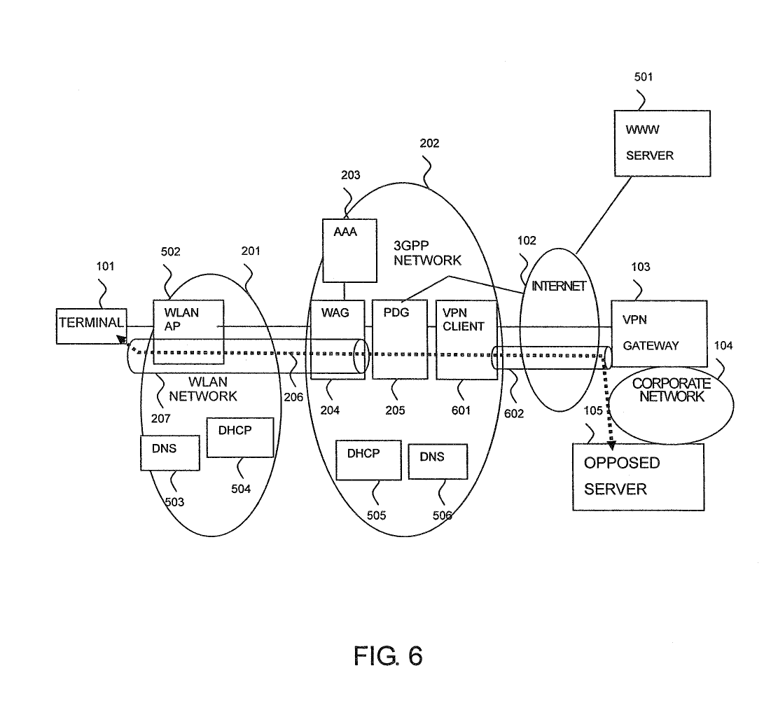

Referring to FIG. 6, the remoter access to a corporate network using an internet connection service of a 3GPP network according to this embodiment will be described below. In FIG. 6, the network comprises a WLAN network (first network) 201, a 3GPP network 202, the internet (second network) 102, and a corporate network (third network) 104. The 3GPP network 202 comprises a WAG 204, a PDG (gateway unit) 205, an AAA (authentication device) 203, a VPN client 601, a DHCP 505, and a DNS 506. The corporate network 104 comprises a VPN gateway 103 and an opposed server 105. The WLAN network 201 connects a terminal 101 via a WLAN Access Point (WLAN AP) to the 3GPP network 202. The internet 102 connects the 3GPP network 202 and the corporate network 104.

Through a communication link 206 between the terminal 101 and the opposed server 105, both the applications communicate in the IP. The VPN client 601 terminates an IPSec with the VPN gateway 103 in place of the terminal 101. Thereby, the VPN client 601 assures the security on the internet 102 by setting an IPSec tunnel (second tunnel) 602 with the VPN gateway 103. Also, the terminal 101 sets an IPSec tunnel (first tunnel) 207 between the terminal 101 and the PDG 205 to assure the security on the WLAN network 201. The functions of the VPN client 601 may be included in the PDG 205.

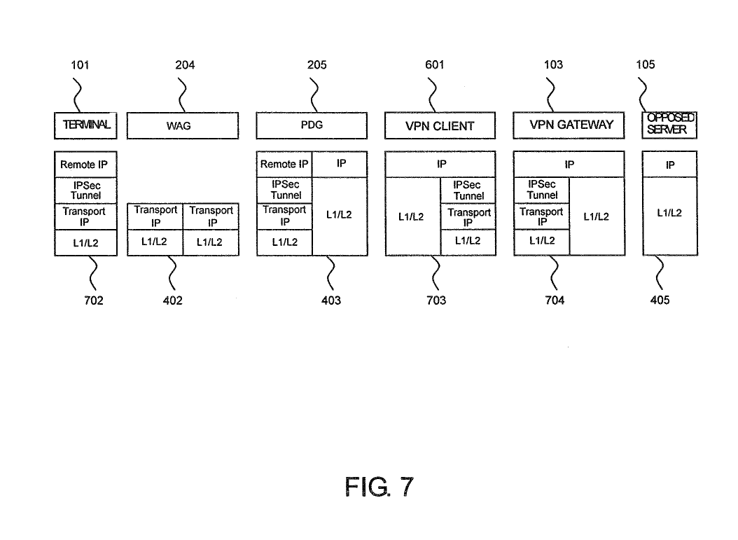

Referring to FIG. 7, a protocol stack for transferring the IP packet between the terminal 101 and the opposed server 105 will be described below. In FIG. 6, a protocol stack 702 of the terminal 101 includes an L1/L2 protocol, a Transport IP protocol, an IPSec Tunnel protocol and a Remote IP protocol in order from the lower layer. A protocol stack 402 of the WAG 204 includes the L1/L2 protocol and the Transport IP protocol in order from the lower layer. A protocol stack 403 of the PDG 205 includes the L1/L2 protocol, the Transport IP protocol, the IPSec Tunnel protocol and the Remote IP protocol on the side of the WAG 402, and the L1/L2 protocol and the IP protocol on the side of the VPN client 601 in order from the lower layer. A protocol stack 703 of the VPN client 601 includes the L1/L2 protocol and the IP protocol on the side of the PDG 205, and the L1/L2 protocol, the Transport IP protocol, the IPSec Tunnel protocol and the IP protocol on the side of the VPN gateway 103 in order from the lower layer. A protocol stack 704 of the VPN gateway 103 includes the L1/L2 protocol, the Transport IP protocol, the IPSec Tunnel protocol and the IP protocol on the side of the VPN client 601, and the L1/L2 protocol and the IP protocol on the side of the opposed server 105 in order from the lower layer. A protocol stack 405 of the opposed server 105 includes the L1/L2 protocol and the IP protocol in order from the lower layer.

In FIG. 7, the terminal 101 and the PDG 205 terminate the IPSec (corresponding to the IPSec tunnel 207 of FIG. 6). Also, the VPN client 601 and the VPN gateway 103 also terminate the IPSec (corresponding to the IPSec tunnel 602 of FIG. 6). The protocol stack 702 of the terminal 101 has one IPSec Tunnel.

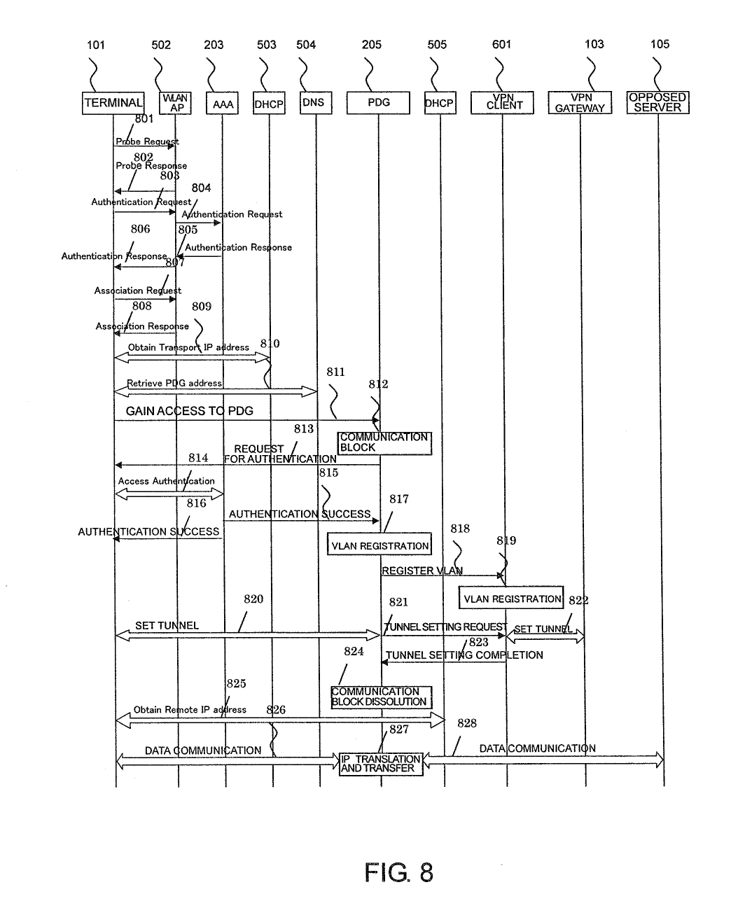

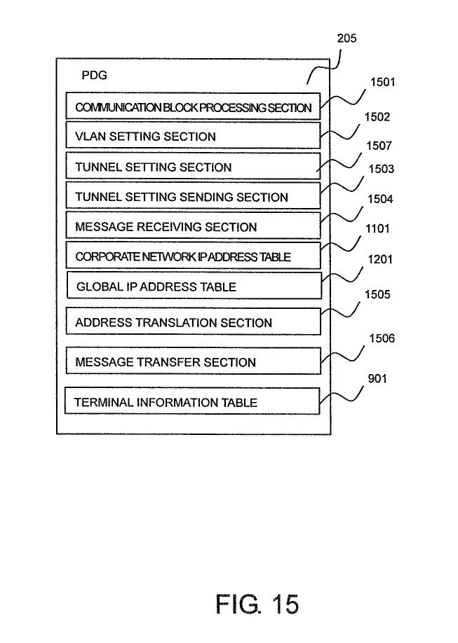

FIG. 15 shows a configuration diagram of the PDG 205. Referring to FIG. 15, each functional unit of the PDG 205 will be described below. The corresponding numerals of the process of FIG. 8 as described below are shown.

A communication block processing section 1501 enables the PDG 205 to block the communication of the terminal 101 (FIG. 8: 812) and request the authentication (813), when the PDG 205 is firstly accessed from the terminal 101. Also, the communication block processing section 1501 dissolves the communication block (824) after being notified of the tunnel setting completion from the VPN client 601 (823).

A VLAN setting section 1502, after being notified of authentication success of the terminal 101 from the AAA 203 (815), registers the VLAN for the terminal 101 to identify the user between the PDG 205 and the VPN client 601, and associates the tunnel of the WLAN network 201 with the tunnel of the corporate network 104 (817). A tunnel setting sending section 1503, after setting the tunnel for the terminal 101 and the PDG 205, sends a request for setting the tunnel between the VPN client 601 and the VPN gateway 103 to the VPN client 601 (821). A message receiving section 1504 receives the packet data via the tunnel of the WLAN network from the terminal 101. As the IP address translation table (address storage section), a corporate network IP address table 1101 that stores the information for translating the source IP address of the packet to the IP address for use within the corporate network 104, and a global IP address table 1201 that stores the information for translating it to the global address are held. Also, a terminal information table (terminal information storage section) 901 is held. An address translation section 1505 searches the IP address table as described above, based on the destination IP address of the received packet and the source IP address of the received packet, and translates the source address of the received packet to the IP address for use within the corporate network 104 or the global address, based on the search result (827). A message transfer section 1506 transfers the packet translated to the IP address for use within the corporate network 104 to the VPN client 601, and transfers the packet translated to the global address to the internet 102.

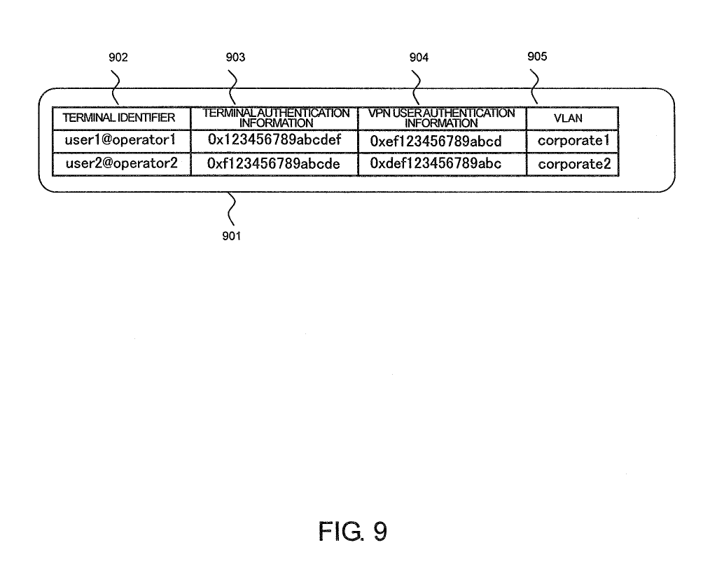

Referring to FIG. 9, the terminal information table 901 held in the PDG 205 will be described below.

The terminal information translation table 901 stores a terminal identifier 902, terminal authentication information 903, VPN user authentication information 904, and a VLAN (VLAN ID) 905 which are associated. In an illustrated example, the first record of the terminal information table 901 holds user1@operator1 as the terminal identifier 902, 0x123456789abcdef as the terminal authentication information 903, 0xef123456789abcd as the VPN user authentication information 904, and corporate1 as the VLAN 905.

The information for identifying the user (or terminal) is the terminal identifier 902. The terminal identifier 902 is the ID of uniquely identifying the user. The terminal authentication information 903 is the authentication information set at the terminal of the 3GPP network 202. The terminal authentication information 903 is preset at the time of registering the terminal. The VPN authentication information 904 is the authentication information for use in the remote access to the corporate network. Herein, the VPN authentication information 904 is the authentication information (pre-shared key) used for an Internet Key Exchange (IKE) that is a key exchange protocol of the IPSec, for example. The VLAN 905 is used to identify the user between the PDG 205 and the VPN client 601. The VLAN 905 is dynamically selected by the PDG 205 when the terminal authentication is successful, held within the PDG 205, and notified to the VPN client 601. These pieces of information may be preset in the AAA 203 and transferred to the PDG 205 when the authentication is successful, or preset in the PDG 205.

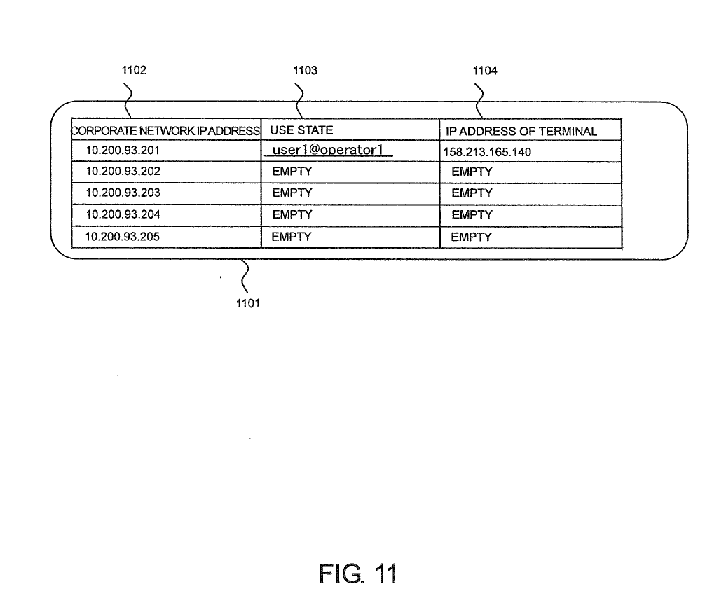

FIG. 11 is an explanatory view of the corporate network IP address table. The corporate network IP address table 1101 includes a use state 1103 and a terminal IP address 1104, associated with a corporate network IP address 1102.

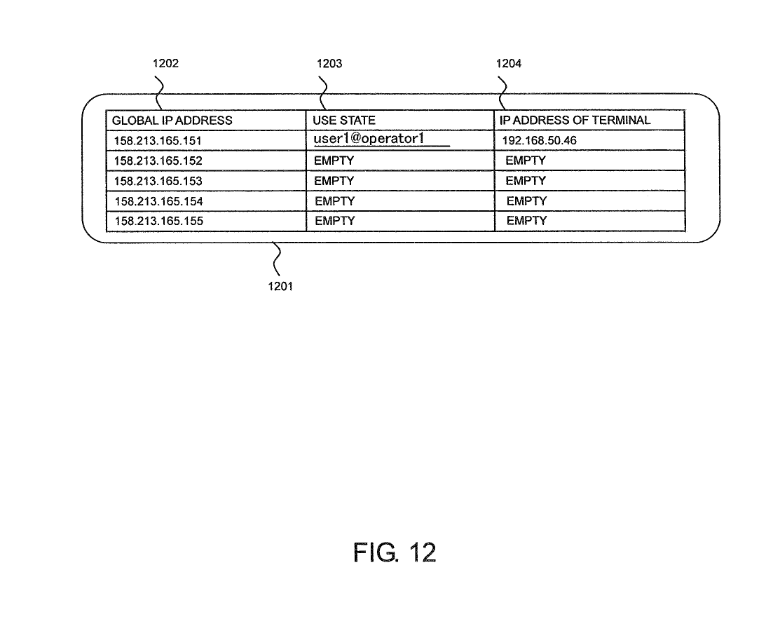

FIG. 12 is an explanatory view of the global IP address table. The global IP address table 1201 includes a use state 1203 and a terminal IP address 1204, associated with a global IP address 1202.

### Operation

Referring to FIG. 8, the operation for the terminal, WLAN AP, AAA, DHCP of the WLAN network, DNS of the WLAN network, PDG, DHCP of the 3GPP network, VPN client, VPN gateway, and the opposed server will be described below.

In FIG. 8, a process that the terminal 101 starts the communication with the opposed server 105 will be described below. The terminal 101 executes a series of WLAN association procedures (801 to 808) with the WLAN AP 502, and after the end of authentication for the WLAN network, establishes the connection with the WLAN AP 502. Herein, the WLAN association procedure is the procedure for new connection as defined in the IEEE802.11. Next, the terminal 101 acquires the Transport IP address from the DHC 503 within the WLAN network 201 (809). The Transport IP address is the private address that is effective only within the WLAN network. Next, the terminal acquires the address of the PDG 205 from the DNS 504 within the WLAN network 201 (810). Since the address of the PDG 205 is acquired, the terminal 101 gains access to the PDG 205 (811). The PDG 205 blocks this communication (812). The PDG 205 requests the authentication for the terminal 101 (813).

The terminal 101 makes the terminal authentication of the 3GPP network with the AAA server 203 (814). In the 3GPP network, the terminal authentication can employ an Extensible Authentication Protocol (EAP)—Subscriber IDentity Module (SIM) or an Authentication and Key Agreement (EAP-AKA). Herein, the authentication normally ends, and the AAA 203 notifies authentication success to the PDG 205 and the terminal 101 (815, 816). The notification (815) of authentication success to the PDG 205 includes various kinds of information 902 to 904 for the terminal 101 to use the remote access of the corporate network 104, and the PDG 205 saves various kinds of information of the terminal 101 in the terminal information table 901 (FIG. 9) within the PDG 205.

After the authentication success is notified from the AAA 203 (815), the PDG 205 selects the ID of VLAN for the terminal 101 from the VLAN ID pool, and registers the VLAN (817). In registering the VLAN, the VLAN ID is saved in the VLAN 905 of the terminal information table 901. The PDG 205 that sets the VLAN requests the VLAN client 601 to register the VLAN selected as the VLAN for the terminal 101 (818), and the VPN client 601 registers the notified VLAN (819). The terminal 101 makes the communication for setting the tunnel with the tunnel setting section 1507 of the PDG 205, and sets the IPSec tunnel between the terminal 101 and the PDG 205 using the authentication information (820). Thereafter, the PDG 205 requests the VPN client 601 to set the tunnel (821). A request for setting the tunnel (821) includes the VPN authentication information 904 of the terminal 101, and the VPN client 601 temporarily saves the VPN authentication information 904 of the terminal 101 within the VPN client 601. The VPN client 601 sets the IPSec tunnel to the VPN gateway 103 using the VPN authentication information 904 of the terminal 101 (819). If the IPSec tunnel between the VPN client 601 and the VPN gateway 103 can be set, the VPN client 601 makes a response of tunnel setting completion to the PDG 205 (823).

The PDG 205 dissolves the communication block (824), if the IPSec tunnels between the terminal and the PDG and between the VPN client and the VPN gateway are set and the setting for the VLAN indicating the correspondence relation of both the IPSec tunnels is ended. If the communication block is dissolved, the communication link is established between the terminal 101 and the opposed server 105 and the communication is started. Thereafter, the terminal 101 acquires the Remote IP address from the DHCP 505 of the 3GPP network (825), and starts the data communication with the opposed server 105 (826). The Remote IP address is the IP address for the corporate network. The PDG 205 makes the IP address translation and transfer (827) in the data communication between the terminal 101 and the opposed server 105.

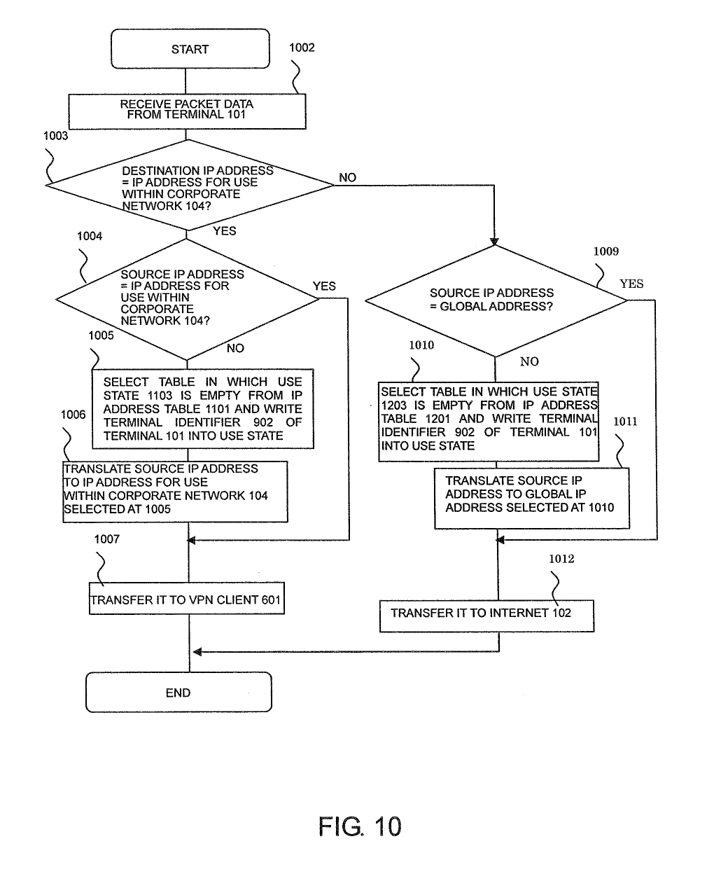

In FIG. 10, the IP address translation and transfer (827) performed by the PDG 205 will be described below. The PDG 205 receives the packet data (also called the message) from the terminal 101 (1002), and determines whether or not the destination IP address of the received packet is the IP address for use within the corporate network 104 (1003). The PDG 205, which holds beforehand the corporate network IP address table 1101 having a list of IP addresses for use within the corporate network 104, determines that the IP address is for use within the corporate network 104, if there is the applicable IP address by referring to the corporate network IP address table 1101 based on the destination IP address of the received packet. If the destination IP address of the received packet is the IP address for use within the corporate network 104 (1003, Yes), it is determined whether or not the source IP address of the received packet is the IP address for use within the corporate network 104 (1004). If the source IP address of the received packet is not the IP address for use within the corporate network 104 (1004, No), the operation passes to step 1005. It is considered that the terminal 101 sends the packet data to the opposed server 105 of the corporate network, using the global IP address. At step 1005, the line (entry) in which the use state 1103 is empty is selected from the corporate network IP address table 1101, the terminal identifier 902 of the terminal 101 is written into the use state 1103, and the IP address of the terminal 101 is written into the IP address 1104 of the terminal 101 (1005). The IP address of the terminal 101 may use the source IP address of the received packet. Thereafter, the source IP address of the received packet is translated to the corporate network IP address 1102 of the selected entry (1006), and then the received packet is transferred to the VPN client 601 (1007). If the source IP address of the received packet is the IP address for use within the corporate network 104 (1004, Yes), the received packet is transferred to the VPN client 601 (1007). This corresponds to a case where the terminal 101 sends the packet data to the opposed server 105 using the private IP address of the corporate network.

On the other hand, if the destination IP address of the received packet is not the IP address for use within the corporate network 104 (1003, No), it is determined whether or not the source IP address of the received packet is the global address (1009). If the source IP address of the received packet is not the global address (1009, No), the operation passes to step 1010. This corresponds to a case where the terminal 101 sends the packet data to the www server 501, using the private IP address of the corporate network, for example. At step 1010, the entry in which the use state 1203 is empty is selected from the global IP address table 1201 held beforehand by the PDG 205, the terminal identifier 902 of the terminal 101 is written into the use state 1203, and the IP address of the terminal 101 is written into the IP address 1204 of the terminal 101 (1010). Thereafter, the source IP address of the received packet is translated to the global IP address 1102 of the selected entry (1011), and then the received packet is transferred to the internet 102 (1012). Also, if the source IP address of the received packet is the global address (1009, Yes), the received packet is transferred to the internet 102 (1012). This corresponds to a case where the terminal 101 sends the packet data to the www server 501 using the global IP address.

The use state written into the corporate network IP address table 1101 having a lift of IP addresses for use within the corporate network 104 and the global IP address table 1201 held beforehand by the PDG 205 is restored to “empty” by the PDG 205 when the terminal 101 disconnects the communication with the PDG 205.

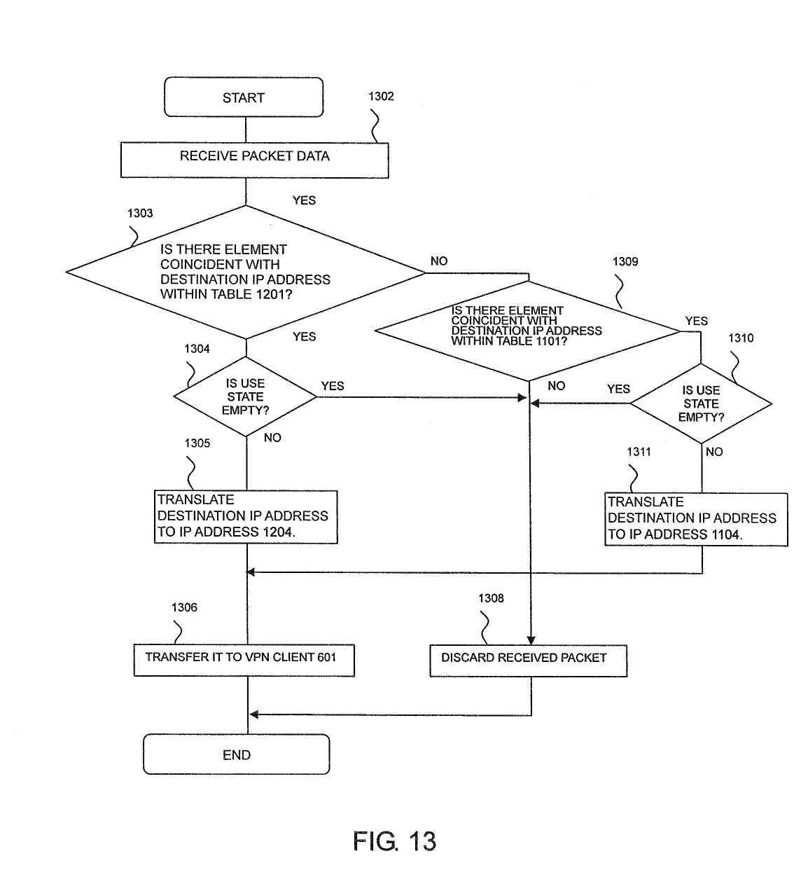

In FIG. 13, the IP address translation and transfer made by the PDG in receiving the data from the opposed server will be described below.

The PDG 205 receives the packet data from the external operation device such as the opposed server 105 or the www server 501 (1302), and searches the global IP address table 1201 for the IP address 1202 coincident with the destination IP address of the received packet data (1303). If there is any coincident element, it is determined whether or not the use state is empty (1304). If so, the received packet is discarded (1308), because the destination of the received packet can not be specified. On the other hand, if the use state 1203 is not empty, it is possible to determine to which terminal the received packet is directed from the terminal identifier 902 as described. If the use state is not empty, the destination terminal can be specified, whereby the destination IP address of the received packet is translated to the IP address 1204 of the terminal in the line (entry) where there is the coincident element (1305), and the received packet is transferred to the VPN client 601 (1007).

If the IP address 1202 coincident with the destination IP address of the received packet data is not found in the global IP address table 1201, the corporate network IP address table 1101 is searched (1309). If the IP address 1102 coincident with the destination address is not found (1309, No), the received packet is discarded (1308). In this case, the received packet may be transferred to the destination address because the address translation is unnecessary. If the IP address 1102 coincident with the destination address is found (1309, Yes), it is determined whether or not the use state is empty (1310), and if so, the received packet is discarded (1308), because the destination of the received packet can not be specified. If the use state is not empty, the destination terminal can be specified, whereby the destination IP address of the received packet is translated to the IP address 1104 of the terminal in the line (entry) where there is the coincident element (1311), and the received packet is transferred to the VPN client 601 (1007).

The network administrator of the corporate network 104 has already introduced a contrivance of the remote user management with the VPN gateway 103, and wishes to use the remote VPN connection through the same interface as the existent access method for the remote VPN access using the 3GPP from the new WLAN network. In accordance with the above embodiment, it is possible to provide the remote VPN connection for the WLAN access service that is newly introduced with the same role sharing as the interface with the conventional remote VPN connection.

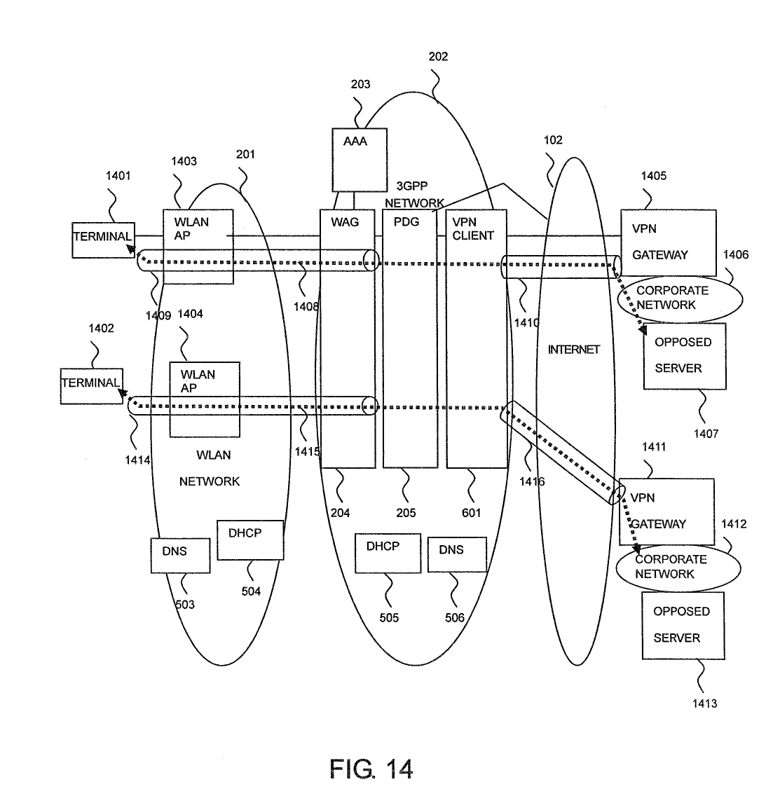

Referring to FIG. 14, the remote access to a plurality of corporate networks using the internet connection service of the 3GPP network will be described below.

In FIG. 14, the network comprises the WLAN network 201, the 3GPP network 202, the internet 102, a corporate network 1406 and a corporate network 1412. The 3GPP network 202 comprises the WAG 204, the PDG 205, the AAA 203, the VPN client 601, the DHCP 505 and the DNS 506. The corporate network 1406 comprises a VPN gateway 1405 and an opposed server 1407. The corporate network 1412 comprises a VPN gateway 1411 and an opposed server 1413. The WLAN network 201 connects a terminal 1401 or 1402 to the 3GPP network 202. The internet 102 connects the 3GPP network 202 to the corporate network 1406 or 1412.

The terminal 1401 is the terminal belonging to the corporate network 1406. The terminal 1402 is the terminal belonging to the corporate network 1412. The terminal 1401 is connected to the opposed server 1407. The terminal 1402 is connected to the opposed server 1413.

A communication link 1408 is the communication link between the terminal 1401 and the opposed server 1407, and a communication link 1415 is the communication link between the terminal 1402 and the opposed server 1413. An IPSec tunnel 1409 is the IPSec tunnel between the terminal 1401 and the PDG 205, which is dynamically set when the communication of the terminal 1401 is active. Similarly, an IPSec tunnel 1414 is the IPSec tunnel between the terminal 1402 and the PDG 205, which is dynamically set when the communication of the terminal 1402 is active.

On the other hand, an IPSec tunnel 1410 is the IPSec tunnel between the VPN client 601 and the VPN gateway 1405, which is dynamically set when the IPSec tunnel between the terminal 1401 and the PDG 205 corresponding to the IPSec tunnel 1410 is active. Similarly, an IPSec tunnel 1416 is the IPSec tunnel between the VPN client 601 and the VPN gateway 1411, which is dynamically set when the IPSec tunnel between the terminal 902 and the PDG 205 corresponding to the IPSec tunnel 1416 is active.

The PDG 205 and the VPN client 601 use the VLAN to identify the flow from the terminal 1401 or 1402. In setting the IPSec tunnel to the terminal, the PDG 205 decides which VLAN (VLAN ID) the terminal uses.

The authentication information for use in the IPSec tunnel between the terminal and the PDG and between the VPN client and the VPN gateway is set in the AAA server, and which VLAN ID the terminal uses can be registered in the AAA server. The information held in the AAA server has the same contents as the terminal information table 901 of FIG. 9.

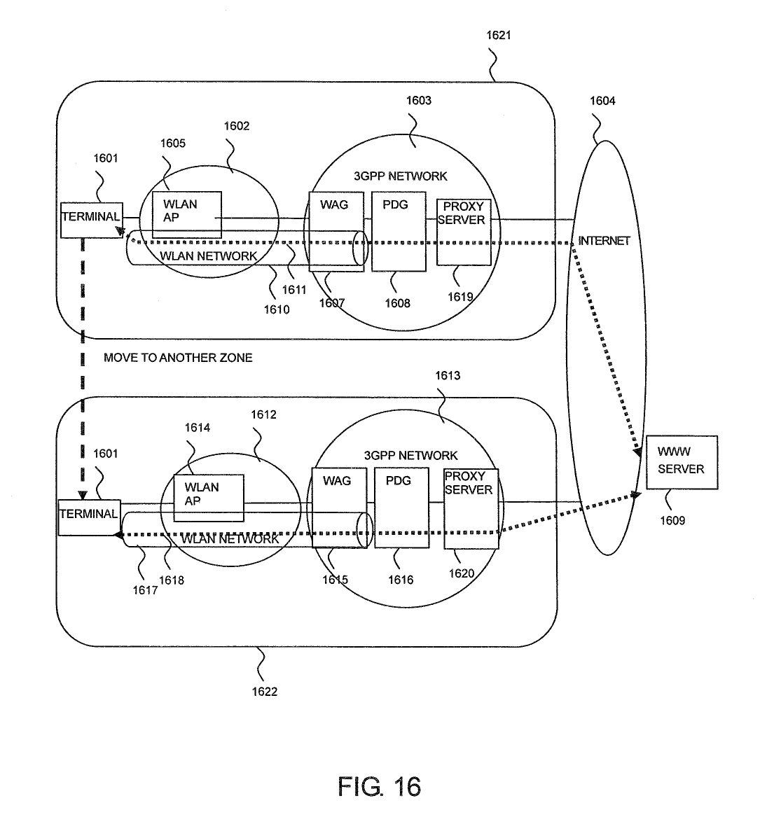

Referring to FIG. 16, the access of the terminal to the WWW server on the internet via the Proxy server will be described below.

In FIG. 16, the network comprises a WLAN network 1602 and a 3GPP network 1603 that exist within the same zone 1621 (e.g., the same prefecture) and the internet 1604. The WLAN network 1602 comprises a WLAN AP 1605. The 3GPP network 1603 comprises a WAG 1607, a PDG 1608 and a Proxy server 1619. The WLAN network 1602 connects a terminal 1601 to the 3GPP network 1603. A WWW server 1609 is the WWW server that exists on the internet 1604. Also, a WLAN network 1612 and a 3GPP network 1613 exist in a different zone 1622 (e.g., within another prefecture) from the WLAN network 1602. The WLAN network 1612 comprises a WLAN AP 1614. The 3GPP network 1613 comprises a WAG 1615, a PDG 1616 and a Proxy server 1620. The WLAN network 1612 connects the terminal 1601 to the 3GPP network 1613. The Proxy server can perform the predetermined processes such as an IP address translation, post-process and proxy process for the NAT, for example.

If the terminal 1601 gains access to the WWW server 1609 via the Proxy server 1619 through a communication link 1611 within a certain zone 1621, and is moved to another zone 1622, it gains access via another WLAN network 1612 in the zone where it is moved. Therefore, at least one Proxy server 1620 is required within another zone 1622. Also, if access is made via any other device than the Proxy server 1602, it is similarly required to install at least one other device at the latter stage of the PDG 1608 or 1616 in each zone. Herein, the zone is in most cases set at such a granularity as prefecture unit, and if the device is distributed in the prefecture units, the service provider has large burden in view of the troublesomeness of operating at the distribution base and the cost of preparing a plurality of devices.

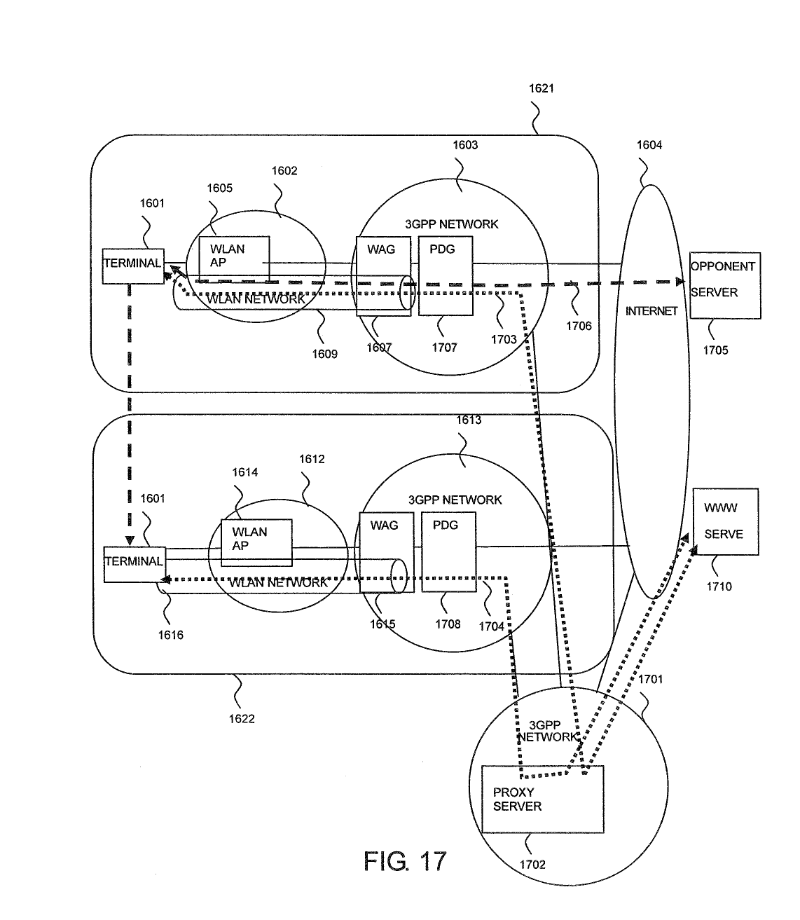

Referring to FIG. 17, the access of the terminal to the WWW server on the internet via the Proxy server in accordance with this embodiment will be described below.

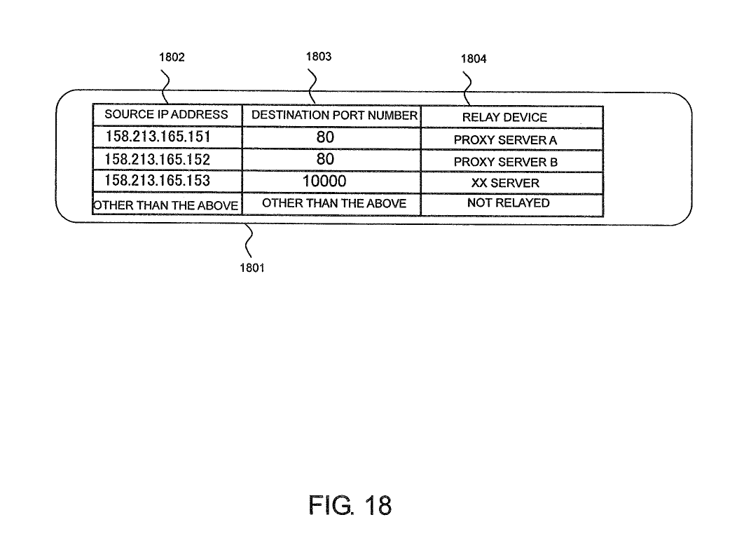

In FIG. 17, a Proxy server (communication device) 1702 exists in a zone 1701 different from the zones 1621 and 1622, in which there is no Proxy server within the zones 1621 and 1622. A PDG 1707 and a PDG 1708, upon receiving the packet data from the terminal 1601, determine whether the destination address of the received packet is the address within the corporate network or the address of the server on the internet. In the case of the address within the corporate network, the received packet is transferred to the VPN client, as previously described. In the case of the address of the server on the internet, a relay device 1804 applicable to a source IP address 1802 of the received packet and a destination port number 1803 of the received packet is retrieved by referring to a transfer destination determination table 1801, and the received packet is transferred to the relay device 1804. FIG. 18 is a configuration diagram of the transfer destination determination table. The transfer destination determination table 1801 prestores the source IP address 1802, the destination port number 1803 and the relay device 1804 which are associated. For example, in FIG. 17, when the terminal 1601 gains access to the WWW server 1608 with the destination port number 80, the PDG 1707 and the PDG 1708 retrieve the Proxy server 1702 as the relay device 1804 from the transfer destination determination table 1801, and transfer the received packet from the terminal 1601 to the Proxy server 1702. Also, if the PDG 1707 and the PDG 1708 select the “not via” as the relay device 1804, as a result of searching the transfer destination determination table 1801 from the received packet, the received packet is directly transferred to the destination IP address on the internet 1604 (e.g., case of the communication link 1706).

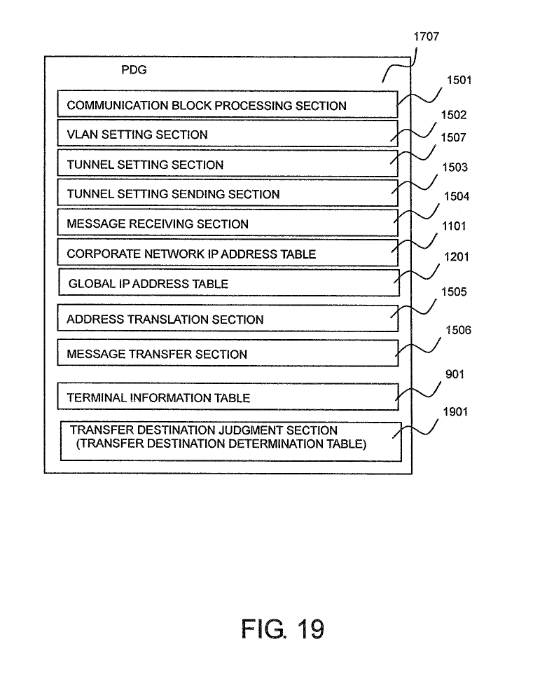

In this embodiment, the PDG further comprises a transfer destination judgment section 1901 for searching the transfer destination determination table 1801 and selecting the relay device 1804, as shown in FIG. 19, and with this transfer destination judgment function, allows the communication device to be intensively installed without need of installing the communication device in each zone.

The invention is applicable to the communication system for providing the remote VPN access service to the corporate network via the 3GPP system.

What is claimed is:

1. A cryptographic communication system comprising:
a gateway device that communicates with a terminal by a cryptographic communication via a first tunnel in a first network, and communicates with a first server via a second network; and
a VPN client device that sets a second tunnel at least on the second network and makes the cryptographic communication via the second tunnel between the gateway device and a second server in a third network;
wherein the gateway device includes:
a message receiving section for receiving a message via the first tunnel from the terminal communicating by using an arbitrary IP address;
an address storage section for storing one or more IP addresses of the second network and the third network to be assigned to the terminal;
an address translation section for selecting one of the IP addresses of the second network or the third network in the address storage section in accordance with a destination of received message, and translating a source address of the message to the selected IP address of the second network or the third network; and
a message transfer section for transferring the address translated message, in accordance with the destination, to the first server or to the second server via the VPN client device.

2. The cryptographic communication system according to claim 1, wherein
the IP address of the second network is a global IP address, and
if the message receiving section receives the message in which the destination IP address is the IP address of the first server in the second network from the terminal using a private IP address, the address translation section selects one global IP address of the second network from the address storage section and translates the source IP address of the message from the private IP address to the selected global IP address.

3. The cryptographic communication system according to claim 1, wherein
the IP address of the third network is the private IP address for use in the third network, and
if the message receiving section receives the message in which the destination IP address is the IP address of the second server in the third network from the terminal using the global IP address, the address translation section selects one private IP address of the third network from the address storage section and translates the source IP address of the message from the global IP address to the selected private IP address.

4. The cryptographic communication system according to claim 1, wherein the terminal and the second server securely communicate via the first tunnel, the gateway device, the VPN client device and the second tunnel.

5. The cryptographic communication system according to claim 4, wherein
the gateway device further comprises a VLAN setting section for registering a VLAN for the terminal to identify the terminal between the gateway device and the VPN client device.

6. The cryptographic communication system according to claim 5, wherein the first tunnel and the second tunnel are associated by the VLAN.

7. The cryptographic communication system according to claim 1, wherein the gateway device further comprises
a tunnel setting section for setting the first tunnel in the first network between the gateway device and the terminal, and
a tunnel setting sending section for sending a request for setting the second tunnel in the second network to the VPN client device.

8. The cryptographic communication system according to claim 7, wherein
the gateway device further comprises a terminal information storage section for prestoring the authentication information of the terminal,
the request for setting to the VPN client device includes the authentication information of the terminal, and
the VPN client device sets the second tunnel for the cryptographic communication with the second server using the authentication information of the terminal.

9. The cryptographic communication system according to claim 8, further comprising
an authentication device for making the authentication of the terminal,
wherein the gateway device acquires the authentication information of the terminal from the authentication device and stores it in the terminal information storage section.

10. The cryptographic communication system according to claim 1, wherein
the IP address of the second network is the global IP address, and the IP address of the third network is the private IP address for use in the third network,
the address translation section stores the global IP address of the terminal in the address storage section in accordance with the source address of the received message, correspondingly to the selected private IP address, or stores the private IP address of the terminal in the address storage section in accordance with the source address of the received message, correspondingly to the selected global IP address.

11. The cryptographic communication system according to claim 10, wherein
the address translation section receives a message from the first server or the second server, the destination address of the message being the selected private IP address or global IP address, acquires the global IP address or private IP address of the terminal corresponding to the destination address by referring to the address storage section based on the destination address of the message, and translates the destination address of received message to acquired global IP address or private IP address, and
the message transfer section transfers the address-translated message to the terminal.

12. The cryptographic communication system according to claim 1, further comprising
a communication device for applying a predetermined processing for the message from the terminal and transferring it to the first server,
wherein the gateway device has
a transfer destination determination table for prestoring relay device information of the message is passed, correspondingly to a destination port number and the source IP address, and
a transfer destination judgment section for judging a transfer destination of the message in accordance with the corresponding relay device information by referring to the transfer destination determination table based on the destination port number and the source IP address included in the message directed to the first server received from the terminal,
wherein the message transfer section transfers the message to the communication device or the first server in accordance with a judgment of the transfer destination judgment section.

13. A gateway device in a system which includes the gateway device that communicates with a terminal by a cryptographic communication via a first network, a first server that communicates with the gateway device via a second network, and a second server of a third network that communicates with the gateway device the cryptographic communication at least in the second network, the gateway device comprising;
a message receiving section for receiving a message by the cryptographic communication from the terminal communicating by using an arbitrary IP address;
an address storage section for storing one or more IP addresses of the second network and the third network to be assigned to the terminal;
an address translation section for selecting one of the IP addresses of the second network or the third network in the address storage section in accordance with a destination of received message, and translating a source address of the message to the selected IP address of the second network or the third network; and
a message transfer section for transferring the address-translated message in accordance with the destination address.

14. The gateway device according to claim 13, wherein
the IP address of the second network is a global IP address, and
if the message receiving section receives the message in which the destination IP address is the IP address of the first server in the second network from the terminal using a private IP address, the address translation section selects one global IP address of the second network from the address storage section and translates the source IP address of the message from the private IP address to the selected global IP address.

15. The gateway device according to claim 13, wherein
the IP address of the third network is the private IP address for use in the third network, and
if the message receiving section receives the message in which the destination IP address is the IP address of the second server in the third network from the terminal using the global IP address, the address translation section selects one private IP address of the third network from the address storage section and translates the source IP address of the message from the global IP address to the selected private IP address.

16. The gateway device according to claim 13, further comprises
a tunnel setting section for setting a first tunnel in the first network between the gateway device and the terminal, and
a tunnel setting sending section for sending a request for setting a second tunnel in the second network.

17. The gateway device according to claim 13, wherein
the IP address of the second network is the global IP address, and the IP address of the third network is the private IP address for use in the third network,
the address translation section stores the global IP address of the terminal in the address storage section in accordance with the source address of the received message, correspondingly to the selected private IP address, or stores the private IP address of the terminal in the address storage section in accordance with the source address of the received message, correspondingly to the selected global IP address.

18. The gateway device according to claim 17, wherein
the address translation section receives a message from the first server or the second server, the destination address of the message being the selected private IP address or global IP address, acquires the global IP address or private IP address of the terminal corresponding to the destination address by referring to the address storage section based on the destination address of the message, and translates the destination address of received message to acquired global IP address or private IP address, and
the message transfer section transfers the address-translated message to the terminal.
